(19) United States
(12) Patent Application Publication
(10) Pub. No.: US 2008/0089741 A1
(43) Pub. Date: Apr. 17, 2008

(54) Fing Device

(75) Inventors: Jean-Jacques Legat, Grenoble (FR); Mohieddine Boubtane, Grenoble (FR); Antoine Raymond, Biviers (FR)

Correspondence Address: BAKER & DANIELS LLP;111 E. WAYNE STREET, SUITE 800, FORT WAYNE, IN, 46802, US

(73) Assignee: A.RAYMOND & CIE, Grenoble (FR)

(21) Appl. No.: 11/718,931

(22) PCT Filed: Oct. 5, 2005
(86) PCT No.: PCT/EP05/10709

§ 371 Date: May 9, 2007

(30) Foreign Application Priority Data
Nov. 12, 2004 (DE) 102004054689.4

(51) Int. Cl. F16B 21/08

(52) U.S. Cl. 403/397

(57) ABSTRACT

The invention relates to a fixing device with a clip base (3) for introduction into a recess. The clip base (3) has a base shaft (4) running from a head piece (1), provided with a number of wings (7, 8), arranged on the peripheral edges of the base shaft (4). The base shaft (4) comprises a number of boundary edges (5, 6), between which a cavity (20) is embodied. The fixing device thus has a relatively light and flexible embodiment.

### BACKGROUND OF THE INVENTION

1. Field of the Invention

The present invention provides a fastening device.

2. Description of the Related Art

FR 2 142 200 A discloses such a fastening device comprising two mutually opposite, relatively solid edge webs of a snap-in foot, which are connected each by one end to a head piece and by their respective other ends to each other via a foot web. Disposed between the edge webs are wings that project radially past the edge webs, each of said wings having one end formed onto the foot web and the other end free. This achieves a certain adaptability to different diameters of recesses in which the fastening device is to be inserted.

GB1 348 753 A discloses a fastening device comprising a snap-in foot for insertion into a recess, wherein the snap-in foot has a foot shaft comprising a number of edge webs between which a cavity is formed and which extend away from the head piece. In this species of fastening device two edge webs are formed, a first edge web being connected to a head part and the other, second edge web being connected to the first edge web via a foot web disposed oppositely to the head piece, while the other end of the second edge web is free. This achieves a certain adaptability to different diameters of recesses in which the fastening device is to be inserted.

A further fastening device is known from DE 100 06 593 A1. This fastening device is provided with a snap-in foot for insertion into a recess and comprising a plate-like foot shaft, which extends away from a head piece and to whose marginal sides two wings are joined.

### SUMMARY OF THE INVENTION

The object of the invention is to specify a fastening device of the aforesaid kind in which the snap-in foot possesses high flexibility and relatively easy-to-execute insertability, combined with a relatively high clamping force.

Due to the fact that in the inventive fastening device, joined to the edge webs are wings that preferably stand out at right angles from the edge webs and extend circular-arc-like around the foot shaft, said edge webs and said wings being configured in accordance with the further inventive features, the inventive fastening device can be inserted with relatively high clamping forces comparatively easily into even tightly dimensioned recesses and nevertheless can be anchored securely in comparatively large-dimensioned recesses.

In one form thereof, the present invention provides a fastening device comprising a snap-in foot (3) for insertion in a recess, wherein said snap-in foot (3) has a foot shaft (4) provided with a number of edge webs (5, 6), which are connected respectively to a head piece (1) and to a foot web (9) and between which a cavity (20) is formed and which extend away from a head piece (1), and with a number of wings (7, 8), characterized in that each said wing (7, 8) is joined to a thereto-assigned edge web (5, 6), wherein each said wing (7, 8) is configured with an immersed portion (21, 22), which is joined to the said head portion (14, 15) of the respective said edge web (5, 6) and which increases in circumference in the direction proceeding away from said head piece (1), wherein each immersed portion (21, 22) is prolonged in the direction of the respective said foot portion (10, 11) by a respective penetratingly engaging portion (23, 24) whose circumference decreases again in the direction of said foot portions (10, 11), and wherein formed in the transitional region between said immersed portions (21, 22) and said penetratingly engaging portions (23, 24) having the largest circumference of said snap-in foot (3) are snap-in surfaces (25, 26) which are oriented toward said head piece (1) and which, when the inventive fastening device is arranged as directed, engage behind the substrate assembly, so that the fastening device is fixedly connected to said substrate assembly; in that each edge web (5, 6) has an outwardly bent middle portion (12, 13); and in that each edge web (5, 6) has a head portion (14, 15) that faces toward said head piece (1) and has a greater material thickness than the remaining material thickness.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of an inventive fastening device comprising a snap-in foot; and

FIG. 2 is a cross section through the snap-in foot of the exemplary embodiment according to FIG. 1.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

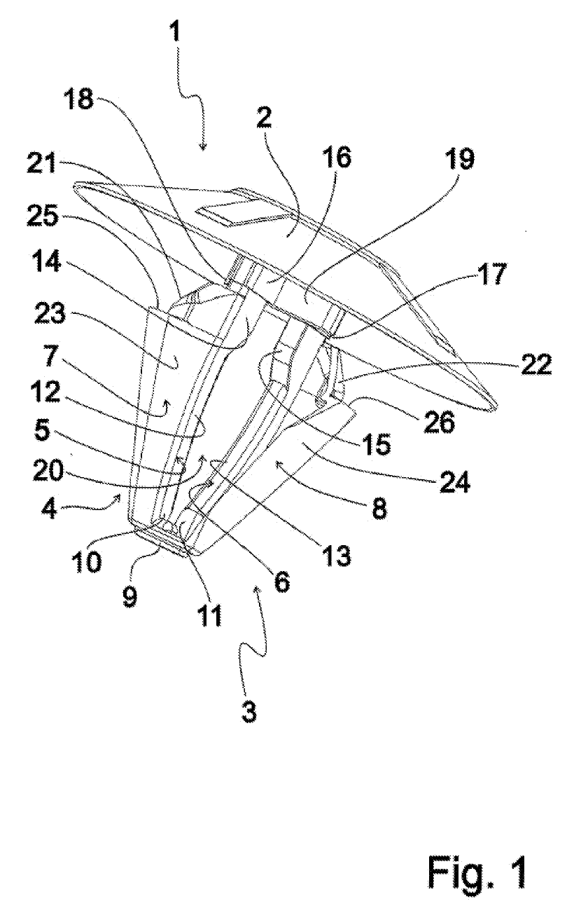

FIG. 1 is a perspective view of an exemplary embodiment of an inventive device, comprising a head piece 1 provided with a funnel-like cover guard 2, which is open in the direction of a snap-in foot 3 of the inventive device. The snap-in foot 3 is insertable in a recess in a two-part substrate assembly (not shown in FIG. 1), for example, comprising two parts that are to be joined together by the fastening device, and in the described exemplary embodiment is provided with a foot shaft 4 that extends away from the head piece 1 and comprises a first edge web 5 and a second edge web 6. Said edge webs 5, 6 are disposed opposite each other. Joined to the outer boundary face of the first edge web 5 is a first wing 7, and a second wing 8 is correspondingly formed on the outer boundary face of the second edge web 6.

The edge webs 5, 6 are connected to each other, at their ends directed away from head piece 1, via a foot web 9 of the foot shaft 4, and comprise, joined to said foot web 9, short foot portions 10, 11 which are disposed substantially parallel to each other, respective longer middle portions 12, 13 which are bent outwardly away from each other, and, again, shorter head portions 14, 15 disposed oppositely to the foot portions 10, 11. The head portions are implemented with a material thickness that is greater than the respective material thicknesses of the foot portions 10, 11 and the middle portions 12, 13, the extra material being found on the mutually confronting inner faces of head portions 14, 15. Head portions 14, 15 are joined to connecting pieces 16, 17, which are connected to the inner face of cover guard 2. Disposed between connecting pieces 16, 17 are stabilizing pieces 18, 19, which together with connecting pieces 16, 17 stabilize cover guard 2 in the central region and promote a stable arrangement of the fastening device in the recess. A cavity 20 is thereby formed in the foot shaft 4, and extends from head piece 1 to foot web 9 and is bounded on two long sides by the edge webs 5, 6.

Each wing 7, 8 of the inventive fastening device is configured with a respective immersed portion 21, 22, which is joined to the head portion 14, 15 of the respective edge web 5, 6 and which increases in circumference in the direction proceeding away from the head piece 1. Each immersed portion 21, 22 is prolonged in the direction of the respective foot portion 10, 11 by a penetratingly engaging portion 23, 24, whose circumference decreases again in the direction of foot portions 10, 11. Formed in the transitional region between the immersed portions 21, 22 and the penetratingly engaging portions 23, 24 having the largest circumference of the snap-in foot 3 are snap-in surfaces 25, 26, which are oriented facing the head piece 1 and which, when the inventive fastening device is arranged as directed, engage behind the substrate assembly, so that the fastening device is fixedly connected to the substrate assembly.

On the one hand, the creation of the cavity 20 brings about a saving in weight compared to a solid foot shaft 4, and on the other hand, the foot shaft 4 of the inventive fastening device has a relatively high flexibility that permits insertion in recesses whose lateral dimensions can vary over a relatively broad range. Moreover, the wings 7, 8, in addition to possessing inherent flexibility, can also be made much smaller in cross section, particularly in the middle region where they are joined to the middle portions 12, 13 of the edge webs 5, 6, by bending said edge webs 5, 6 together.

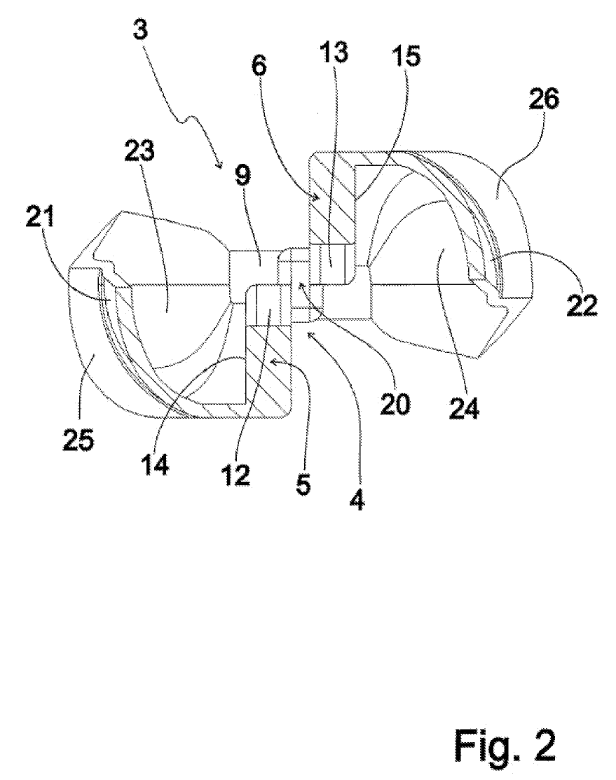

FIG. 2 shows a cross section through the snap-in foot 3 of the exemplary embodiment of FIG. 1 in the region of immersed portions 21, 22, looking toward foot web 9. It can be seen from FIG. 2 that the edge webs 5, 6 are offset laterally to each another with respect to a central plane, making the inventive fastening device relatively easy to produce by injection molding.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-4. (canceled)

5. A fastening device for engaging a recess in a substrate assembly, said fastening device comprising:
a head piece (1); and
a snap-in foot (3) for insertion in the recess, said snap-in foot (3) comprising:
a foot shaft (4) provided with a plurality of edge webs (5, 6) connected respectively to said head piece (1) and to a foot web (9);
a cavity (20) formed between said edge webs (5, 6);
said edge webs (5, 6) extending away from said head piece (1) and having a plurality of wings (7, 8) each joined to a respective edge web (5, 6), each said wing (7, 8) including an immersed portion (21, 22) which is joined to the said head portion (14, 15) of a respective said edge web (5, 6) and which increases in circumference in a direction proceeding away from said head piece (1), each immersed portion (21, 22) elongated in the direction of the respective said foot portion (10, 11) by a respective penetratingly engaging portion (23, 24) whose circumference decreases in the direction of said foot portions (10, 11);
snap-in surfaces (25, 26) formed in a transitional region between said immersed portions (21, 22) and said penetratingly engaging portions (23, 24) having a largest circumference of said snap-in foot (3), said snap-in surfaces (25, 26) oriented toward said head piece (1) and engagable behind the substrate assembly to fix the fastening device to the substrate assembly; and
each edge web (5, 6) having an outwardly bent middle portion (12, 13) and a head portion (14, 15) facing toward said head piece (1) and having a greater material thickness than the remaining material thickness.

6. The fastening device of claim 5, wherein said edge webs (5, 6) are connected to each other at their respective ends facing away from said head piece (1) by a foot web (9) of said foot shaft (4).

7. The fastening device of claim 5, wherein said edge webs (5, 6) are formed, at their respective ends facing toward said head piece (1), onto connecting pieces (16, 17) that are connected to said head piece (1).

8. The fastening device of claim 5, comprising two mutually confronting edge webs (5, 6) disposed offset with respect to a central plane of said fastening device.
